(19) United States
(12) Patent Application Publication
(10) Pub. No.: US 2008/0267852 A1
(43) Pub. Date: Oct. 30, 2008

(54) Process for Preparing Pulverulent Solids

(75) Inventors: Kai Schumacher, Hofheim (DE); Stefan Fiedler, Loerrach (DE); Roland Schilling, Freigericht (DE); Ronald Ihmig, Neuberg (DE); Stipan Katusic, Bad Soden (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/158,701

(22) PCT Filed: Nov. 29, 2006
(86) PCT No.: PCT/EP06/69057

§ 371 Date: Jun. 23, 2008

(30) Foreign Application Priority Data
Dec. 23, 2005 (DE) 102005061897.9

(51) Int. Cl. C01B 33/18; C01B 13/20; C01B 13/22; C01G 49/06; C01F 7/30; C01B 13/24

(52) U.S. Cl. 423/337; 423/592.1; 423/604; 423/613; 423/625; 423/633; 423/643

(57) ABSTRACT

Process for preparing pulverulent solids, in which one or more oxidizable and/or hydrolysable metal compounds are reacted in a high-temperature zone in the presence of oxygen and/or steam, the reaction mixture is cooled after the reaction, and the pulverulent solid is removed from gaseous substances, wherein at least one metal compound is introduced into the high-temperature zone in solid form and the evaporation temperature of the metal compound is below the temperature of the high-temperature zone.

The invention relates to a process for preparing pulverulent solids by reacting a metal compound with oxygen and/or steam in a high-temperature zone. The invention further relates to pulverulent solids obtainable by this process and to their use.

It is known that metal oxide powders can be prepared by means of pyrogenic processes. Commonly, metal compounds are evaporated and the vapours are converted to the oxides in a flame in the presence of oxygen and/or steam. These pyrogenic processes are known in the literature as flame oxidation or flame hydrolysis. The disadvantage of this process is the availability of metal compounds whose evaporation temperature is sufficiently high that they can be evaporated under economically viable conditions. They may, for example, be silicon tetrachloride, titanium tetrachloride or aluminium chloride. These compounds are associated with industrial scale substances, for example Aerosil®, pyrogenic silica powders from Degussa.

Even neglecting the economic aspect, it is difficult to find materials for evaporators which are stable at high evaporation temperatures, often under corrosive conditions. This leads to a limitation in the number of pyrogenically preparable oxides.

It was therefore an object of the invention to provide a process which overcomes the disadvantages of the known processes. In particular, the process should be performable in an economically viable manner. It was a further object of the invention to provide pulverulent solids which, to date, have been preparable only in a restricted manner, if at all, owing to the high evaporation temperatures of the starting compounds.

The invention provides a process for preparing pulverulent solids, in which one or more oxidizable and/or hydrolysable metal compounds are reacted in a high-temperature zone in the presence of oxygen and/or steam, the reaction mixture is cooled after the reaction, and the pulverulent solid is removed from gaseous substances, characterized in that at least one metal compound is introduced into the high-temperature zone in solid form, the evaporation temperature of the metal compound being below the temperature of the high-temperature zone.

The temperature of the high-temperature zone may preferably be 400 to 3000° C.

The reason for the advantage of the process according to the invention is in particular that the temperature of the high-temperature zone is utilized in order to evaporate metal compounds with high evaporation temperature and to react them immediately. Even in the case of metal compounds which have a comparatively low evaporation temperature, it is now possible to dispense with external evaporators with the process according to the invention.

In the context of the invention, hydrolysable is understood to mean that the metal compounds are converted in the presence of steam to solid metal oxides and a by-product which is gaseous under the reaction conditions. Examples thereof are:

TiCl₄+2H₂O→TiO₂+4HCl; Si(OEt)₄+2H₂O→SiO₂+4EtOH.

In the context of the invention, oxidizable is understood to mean that the metal compounds are converted in the presence of oxygen to solid metal oxides and a gaseous by-product. An example thereof is:

ZrCl₄+O₂→ZrO₂+2Cl₂.

The size of the metal compounds added in solid form may be within a range of several centimetres down to nanoscale dimensions. The particle size depends both on apparatus parameters, for example the flame temperature, and on substance parameters, for example evaporation temperature of the metal compound. In general, the size of the metal compounds added in solid form is 0.1 to 5000 μm, preferably 1 to 1000 μm.

The metal compound can be introduced into the high-temperature zone in any manner known to those skilled in the art. For example, the metal compound can be introduced by means of a metering screw, or in the form of an aerosol.

The metal compound may be supplied to the high-temperature zone by means of a carrier gas which may be inert or reactive (for example air, oxygen, nitrogen).

In a preferred embodiment of the invention, the high-temperature zone is formed by a flame which arises from the reaction of an oxygenous gas with a hydrogenous combustion gas. A suitable oxygenous gas is in particular air and oxygen-enriched air. Suitable combustion gases are in particular hydrogen, methane, ethane, propane, butane, natural gas. The manner in which the flame temperature can be varied is known to those skilled in the art.

Also known to those skilled in the art are flame types which are suitable for performing the process according to the invention, for example laminar or turbulent flames, premixed flames or diffusion flames, low-pressure or high-pressure flames, flames which spread below, at or above the speed of sound, pulsating or continuous flames, reducing or oxidizing flames, secondary flames, closed or open flames, flames from one or more burners, or a mixed form of the aforementioned flame types.

The type of the solid metal compound is not limited. The process according to the invention is indeed notable for the problem-free introduction as a solid. The solid metal compound may preferably contain, as the metal component, Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Si, Sm, Sn, Sr, Ta, Tb, Ti, Tl, Tm, V, W, Y, Yb, Zn, Zr or a mixture of the aforementioned elements. Particular preference is given to Ag, Al, K, Ti, Er, Fe, P, Ta, Yb, Zr.

In addition, the solid metal compound may preferably be a chloride, a nitrate, a sulphate, an alkoxide, a carbonate, a carboxylate, an acetylacetonate or a carbonyl.

In the process according to the invention, at least one metal compound is supplied in solid form to the high-temperature zone. Further metal compounds may be supplied to the high-temperature zone in vaporous, liquid, dissolved or suspended form. This also includes the possibility that a metal compound is supplied to the high-temperature zone partly in solid form and partly in liquid/gaseous form. For this purpose, suitable metal compounds are those which contain, as the metal component, Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Si, Sm, Sn, Sr, Ta, Tb, Ti, Tl, Tm, V, W, Y, Yb, Zn, Zr or a mixture thereof. In particular, suitable metal compounds are chlorides, nitrates, sulphates, carbonates, carboxylates, alkoxides, acetylacetonates or carbonyls.

With very particular preference, the following compounds may be used: SiCl₄, CH₃SiCl₃, (CH₃)₂SiCl₂, (CH₃)₃SiCl, (CH₃)₄Si, HSiCl₃, (CH₃)₂HSiCl, CH₃C₂H₅SiCl₂, disilanes with the general formula RₙCl₃₋ₙSiSiRₘCl₃₋ₘ where R═CH₃ and n+m=2, 3, 4, 5 and 6, Si(OCH₃)₄, Si(OC₂H₅)₃, AlCl₃, Al (OisoC₃H₇), Al (Oiso-sec-C₄H₉), TiCl₄, Ti (OiC₃H₇)₄.

In the process according to the invention, oxygen and/or steam may preferably be present in such amounts that the metal compounds are converted completely.

However, it is also possible to use oxygen and/or steam in substoichiometric amounts, so that the metal compound used is not converted completely. In these preferred embodiments, the amount of oxygen and/or steam is selected such that 95 to 99.9% of the metal compound used is converted.

The invention further provides a pulverulent solid obtainable by the process according to the invention. The pulverulent solid may preferably have a uniform chemical composition. In addition, it may be present as a physical and/or chemical mixture of compounds. The pulverulent solid is generally present predominantly in the form of aggregated primary particles. The primary particles generally do not have any pores. However, it is also possible to prepare particles having a surface roughness which constitutes a transition to micropores. Pores can, though, form within the arms of an aggregate or between aggregates. The surfaces of the primary particles generally have hydroxyl groups. The BET surface area of the inventive pulverulent solid may be 1 to 800 m²/g, particular preference being given to the range of 30 to 400 m²/g.

The pulverulent solid will preferably be a metal oxide powder, a mixed metal oxide powder or a metal-metal oxide powder. Metal oxide powder is understood to mean a powder composed of particles of a metal oxide, for example titanium dioxide or zirconium dioxide. Mixed metal oxide powder is understood to mean a powder in which there is intimate mixing of different metal oxides at the level of the primary particles or of the aggregates. The primary particles have bonds of the M(I)—O-M(II), M(I)—O-M(n) type, where M(I) is the metal of a first metal compound, M(II) the metal of a second metal compound and M(n) the metal of an nth metal compound. Metal-metal oxide powders are understood to mean those powders in which one component is present in non-oxidized form. Examples thereof are platinum-zirconium dioxide or gold-titanium dioxide.

The content in the component or the components of a mixed oxide powder or metal-metal oxide powder which is supplied to the high-temperature zone of the process according to the invention in the form of solid metal compounds is not restricted. In the case of mixed oxide powders or metal-metal oxide powders in which the metal compound of the main component has a low evaporation temperature and the metal compound of the secondary component a high evaporation temperature, it may be economically viable to supply only the metal compound of the secondary component in solid form, but to evaporate the metal compound of the main component externally.

The metal oxide powder or mixed oxide powder generally has a purity of at least 99% by weight. The purity may preferably be more than 99.5% by weight and more preferably more than 99.7% by weight. Impurities may originate from the feedstocks or result from the process.

The invention further provides for the use of the inventive pulverulent solid as a filler, as a carrier material, as a catalytically active substance, as a ceramic base material.

### EXAMPLES

### Example 1

2.2 m³ (STP)/h of hydrogen and 6.5 m³ (STP)/h of primary air are transferred into the mixing chamber of a burner. The mixture is ignited and combusted in a flame entering a reaction chamber. 4.5 kg/h of aluminium trichloride are metered into the flame by means of a metering screw. Additionally introduced into the reaction chamber are 20 m³ (STP)/h of secondary air. In a filter or cyclone, the solid is then removed from the offgas stream and subsequently treated with steam at a temperature of approx. 700° C.

### Examples 2-4

Are performed analogously to Example 1. Feedstocks and reaction conditions can be found in Table 1.

### Example 5

8 kg/h of vaporous silicon tetrachloride are transferred into the mixing chamber of a burner. At the same time, 4.5 m³ (STP)/h of hydrogen and 11.9 m³ (STP)/h of primary air are introduced into the mixing chamber. The mixture is ignited and combusted in a flame entering a reaction chamber. 21 g/h of potassium chloride are metered into the flame by means of a metering screw. Additionally introduced into the reaction chamber are 30 m³ (STP)/h of secondary air. In a filter or cyclone, the solid is then removed from the offgas stream and subsequently treated with steam at a temperature of approx. 500° C.

### Examples 6-8

Are performed analogously to Example 5.

### Examples 9-10

Are likewise performed like Example 5, except with silver nitrate in place of potassium chloride.

### Example 11 is likewise performed like Example 5, but with titanium tetrachloride in place of silicon tetrachloride and iron(II) chloride in place of potassium chloride.

The analytical values of the resulting pulverulent solids can be found in Table 2.

TABLE 1
Feedstocks and reaction conditions

| | Metal compound | | | | | Reaction gases | | | Temperature |
|---|---|---|---|---|---|---|---|---|---|
| | Solid 1 | | | | | | Air | | of high- |
| | | | Evapor- | Vaporous | | H₂ | Primary | Secondary | temperature |
| | | Amount | ator temp. | | Amount | m³ | m³ | m³ | zone |
| Ex. | Type | g/h | ° C. | Type | kg/h | (STP)/h | (STP)/h | (STP)/h | ° C. |
| 1 | AlCl₃ | 4500 | >185 | — | — | 2.2 | 6.5 | 20 | 2016 |
| 2 | AlCl₃ | 4500 | >185 | — | — | 2.4 | 9.5 | 17 | 1612 |
| 3 | AlCl₃ | 4500 | >185 | — | — | 2.5 | 6.5 | 20 | 2215 |
| 4 | AlCl₃ | 4500 | >185 | — | — | 2.2 | 7.5 | 20 | 1810 |
| 5 | KCl | 21 | 1500 | SiCl₄ | 8 | 4.5 | 11.9 | 30 | 1907 |
| 6 | KCl | 21 | 1500 | SiCl₄ | 6.5 | 2.2 | 4.7 | 30 | 2121 |
| 7 | KCl | 41 | 1500 | SiCl₄ | 8 | 4.5 | 11.9 | 30 | 1996 |
| 8 | KCl | 41 | 1500 | SiCl₄ | 6.5 | 2.2 | 4.7 | 30 | 2121 |
| 9 | AgNO₃ | 0.55 | >444 | SiCl₄ | 8 | 4.5 | 10 | 20 | 2203 |
| 10 | AgNO₃ | 0.55 | >444 | SiCl₄ | 8 | 4.5 | 8.6 | 20 | 2387 |
| 11 | FeCl₃ | 0.48 | >280 | TiCl₄ | 1.6 | 0.3 | 3.1 | 2 | 866 |

TABLE 2
Analytic values of the resulting pulverulent solids

| | |
|---|---|
| Oxide 1 | Oxide 2 |

| | BET | | Content | | Content |
|---|---|---|---|---|---|
| Ex. | m²/g | Type | % by wt. | Type | % by wt. |
| 1 | 98 | Al₂O₃ | 100 | — | — |
| 2 | 155 | Al₂O₃ | 100 | — | — |
| 3 | 90 | Al₂O₃ | 100 | — | — |
| 4 | 106 | Al₂O₃ | 100 | — | — |
| 5 | 275 | SiO₂ | 99.43 | K₂O | 0.42 |
| 6 | 289 | SiO₂ | 99.38 | K₂O | 0.54 |
| 7 | 281 | SiO₂ | 99.01 | K₂O | 0.88 |
| 8 | 285 | SiO₂ | 98.77 | K₂O | 1.07 |
| 9 | 203 | SiO₂ | 98.26 | Ag₂O | 1.60 |
| 10 | 129 | SiO₂ | 98.19 | Ag₂O | 1.62 |
| 11 | 56 | TiO₂ | 73.68 | Fe₂O₃ | 26.12 |

1: A process for preparing pulverulent solids, in which one or more oxidizable and/or hydrolysable metal compounds are reacted in a high-temperature zone in the presence of oxygen and/or steam, the reaction mixture is cooled after the reaction, and the pulverulent solid is removed from gaseous substances, characterized in that
at least one metal compound is introduced into the high-temperature zone in solid form, the evaporation temperature of the metal compound being below the temperature of the high-temperature zone.

2: The process according to claim 1, characterized in that the solid metal compound has a particle size of 0.1 to 5000 μm.

3: The process according to claim 1, characterized in that the high-temperature zone is a flame formed by reaction of an oxygenous gas with a hydrogenous combustion gas.

4: The process according to claim 1, characterized in that the solid, oxidizable and/or hydrolysable metal compound contains, as the metal component, Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Si, Sm, Sn, Sr, Ta, Tb, Ti, Tl, Tm, V, W, Y, Yb, Zn, Zr or a mixture thereof.

5: The process according to claim 1, characterized in that the solid, oxidizable and/or hydrolysable metal compound is a chloride, a nitrate, a sulphate, a carbonate, an alkoxide, a carboxylate, an acetylacetonate or a carbonyl.

6: The process according to claim 1, characterized in that, in addition to the solid metal compound, at least one further oxidizable and/or hydrolysable metal compound is introduced into the high-temperature zone, the metal compound being present in vaporous, liquid, dissolved or suspended form.

7: The process according to claim 6, characterized in that the vaporous, oxidizable and/or hydrolysable metal compound contains, as the metal component, Ag, Al, As, Au, B, Ba, Be, Bi, Ca, Cd, Ce, Co, Cr, Cs, Cu, Er, Eu, Fe, Ga, Gd, Ge, Hf, In, K, La, Li, Mg, Mn, Mo, Na, Nb, Nd, Ni, P, Pb, Pd, Pm, Pr, Pt, Rb, Ru, Sb, Sc, Si, Sm, Sn, Sr, Ta, Tb, Ti, Tl, Tm, V, W, Y, Yb, Zn, Zr or a mixture thereof.

8: The process according to claim 6, characterized in that the vaporous, oxidizable and/or hydrolysable metal compound is a chloride, a nitrate, a sulphate, a carbonate, a carboxylate, an acetylacetonate or a carbonyl.

9: The process according to claim 1, characterized in that the amount of oxygen and/or steam is at least sufficient to completely convert the metal compound.

10: A pulverulent solid obtainable by the process according to claim 1.

11: The pulverulent solid according to claim 10, characterized in that the pulverulent solid is a metal oxide powder, a mixed metal oxide powder or a metal-metal oxide powder.

12: A method of using the pulverulent solid according to claim 10 as a filler, as a support material, as a catalytically active substance and as a ceramic base material.
